(19) United States
(12) Patent Application Publication
(10) Pub. No.: US 2014/0225549 A1
(43) Pub. Date: Aug. 14, 2014

(54) METHOD AND APPARATUS FOR LIMITING A POWER CONSUMPTION OF AN ELECTRIC MOTOR IN THE EVENT OF OVERLOAD IN A HANDHELD POWER TOOL

(71) Applicant: Robert Bosch GmbH, Stuttgart (DE)

(72) Inventors: Manfred Lutz, Filderstadt (DE); Kamil Pogorzelski, Stuttgart (DE); Joern Stock, Bempflingen (DE)

(73) Assignee: Robert Bosch GmbH, Stuttgart (DE)

(21) Appl. No.: 14/179,485

(22) Filed: Feb. 12, 2014

(30) Foreign Application Priority Data
Feb. 14, 2013 (DE) 10 2013 202 434.7

(51) Int. Cl. H02P 29/02

(52) U.S. Cl. CPC H02P 29/028
USPC 318/434

(57) ABSTRACT

A method for limiting a power consumption in the event of overload of an electrical drive, in particular an electric motor of a handheld power tool, by outputting power to the electrical drive and controlling the voltage of the electric motor using at least one circuit breaker. At least the control signal and therefore the power consumption of the electric motor are adapted if an overload torque and/or the power consumption is/are exceeded such that the handheld power tool is operated in a protective mode with a defined, reduced power. At least the control signal for the voltage of the electric motor and therefore the power consumption of the electric motor are reduced in the protective mode with reduced power in an interval of time that is greater than an integer multiple of half the period time of the mains frequency if the overload torque is not reduced.

This application claims priority under 35 U.S.C. §119 to patent application no. DE 10 2013 202 434.7 filed on Feb. 14, 2013 in Germany, the disclosure of which is incorporated herein by reference in its entirety.

### BACKGROUND

The disclosure relates to a method and an apparatus for limiting a power consumption of an electric motor in the event of overload, in particular for use in a handheld power tool.

The document EP 0771619 mentions a method for interrupting the drive action of a handheld power tool, which interrupts the rotary drive action in the event of jamming of the motor by causing the rotary drive action to be interrupted by means of decoupling in the drive train or by switching off a drive motor of the handheld power tool or by abruptly connecting a housing of the handheld power tool to the drive train.

This control has the disadvantage, in particular, that it is possible to switch on the handheld power tool again only after a defined period of time or after defined operation of the tool, for example switching the tool off and on again at the switch. This is not user-friendly for an operator of the handheld power tool.

### SUMMARY

The disclosure solves the problem from the prior art by means of a method for limiting a power consumption by controlling and/or regulating a voltage of an electric motor and by means of a control and regulation circuit. The method according to the disclosure can be used, in particular, in a handheld power tool, for example an angle grinder. It prevents the disadvantages associated with the solutions in the prior art.

It is proposed to reduce at least a power consumption at the electric motor for the purpose of overload protection in the event of the handheld power tool being overloaded. For this purpose, at least a voltage of the electric motor is controlled using a control element which comprises at least the following steps:
a detection system detects at least one parameter which characterizes the power consumption of the electrical drive,
a computation and control unit calculates at least one control signal for the voltage of the electric motor using a desired value/actual value comparison of the parameter,
at least the control signal for the voltage of the electric motor and therefore the power consumption of the electric motor are adapted if an overload torque and/or the power consumption is/are exceeded, with the result that the handheld power tool is operated in a protective mode with a defined, reduced power. At least the power consumption of the electric motor is reduced in the protective mode with reduced power in an interval of time which is greater than an integer multiple of half the period time of the mains frequency if the overload torque is not reduced.

A detection system is intended to be understood as meaning, in particular, speed detection using speedometer signal detection or detection of the motor current using a measuring resistor or detection of a voltage at the armature of the electric motor. However, the detection system may also detect the temperature in the electric motor.

The parameter which characterizes the power consumption of the electrical drive is intended to be understood as meaning at least one of the following parameters of the electric motor: a load torque, the overload torque, a speed, a current, an armature voltage and/or a temperature. The load torque describes a torque which is produced by a workpiece as a counter-torque to a drive torque.

An increase in the load torque during ongoing operation results in a reduction in the speed. A reduction in the speed increases the current drawn by the electric motor and/or the voltage and in the process reduces the cooling effect of a fan, with the result that the temperature, measured in the electric motor, increases. The power consumption above a limit value can consequently be detected and/or monitored using at least one of the following parameters: exceeding of the overload torque, undershooting of a limit value for the speed, exceeding of a limit value for the current, exceeding of a limit value for the armature voltage and/or exceeding of a limit value for the temperature. One or more parameters may be monitored in a parallel manner. The overload torque is intended to be understood as meaning the torque, the exceeding of which results in the temperature increase becoming critical for the components of the electric motor, that is to say destruction of the electric motor can no longer be excluded.

A computation and control unit is intended to be understood as meaning, in particular, a component having a processor, a main memory and/or a program memory as well as interfaces which make it possible to communicate with the environment. Such a computation and control unit may be a microcontroller, for example.

The computation and control unit calculates at least one control signal for the voltage of the electric motor using a desired value/actual value comparison of at least one value of the parameter which characterizes the power consumption.

The voltage of the electric motor is intended to be understood as meaning at least an armature voltage and/or a stator voltage. While at least the armature voltage is detected by the detection system, at least the total voltage, both the armature voltage and the stator voltage of the electric motor, is controlled. In this case, the voltage of the electric motor is controlled using the computation and control unit.

In this case, the voltage of the electric motor is intended to be reduced in at least one interval of time which is, in particular, greater than an integer multiple of half the period time of the mains frequency. This advantageously protects the components of the electric motor from overheating. However, the handheld power tool advantageously does not switch off in this case, but rather is operated in a protective mode with a defined, reduced power.

Advantageous developments of the method are possible as a result of the features cited in the subclaims.

It is proposed to increase at least the speed of the electric motor again in the protective mode of the handheld power tool if the overload torque is reduced.

In this case, at least the parameter which characterizes the power consumption of the electrical drive advantageously continues to be monitored by the detection system.

In one particularly advantageous embodiment, at least the voltage of the electric motor is used as a control signal. However, it is also conceivable for the current to be used as a control signal, for example.

It is proposed to adapt at least the control signal for the voltage of the electric motor and to reduce the voltage of the electric motor in an interval of time which is, in particular, greater than an integer multiple of half the period time of the mains frequency if the overload torque and/or the power consumption of the electric motor is/are exceeded. This can be carried out in a linear, stepwise or exponential manner. An exponential change of the voltage signal output to the electric motor can be effected in a progressive or degressive manner.

In this case, “stepwise” is intended to be understood as meaning the fact that the voltage signal output to the electric motor by the control element changes in a stepped profile with respect to the parameter detected by the detection system. In this case, “linear” is intended to be understood as meaning the fact that the voltage signal output to the electric motor by the control element changes in proportion with the parameter detected by the detection system. In this case, “exponential” is intended to be understood as meaning the fact that the voltage signal output to the electric motor by the control element changes in an exponential manner with respect to the parameter detected by the detection system. In this case, exponentially progressive means exponentially increasing and denotes the opposite of regressive.

The mains frequency used is territorially different. A mains frequency of 50 Hz is used in Europe and a mains frequency of 60 Hz is used in North America, for example. The voltage of the electric motor is reduced in an interval of time which is, in particular, greater than 10 ms in Europe and is reduced in an interval of time which is greater than 8.3 ms in North America.

The voltage of the electric motor is advantageously controlled and/or regulated by varying a voltage signal using pulse width modulation. In this case, a pulse-width-modulated signal is generated with the aid of the control element in such a manner that the average power consumption of the electric motor is reduced. The power consumption is defined via the voltage in this case. Simple, cost-effective and low-loss switching is therefore possible.

Another advantageous embodiment is the regulation of the voltage of the electric motor using phase-gating control of the voltage signal. In this case, a firing angle of the phase-gating control is increased with the aid of the circuit breaker in order to reduce the voltage of the electric motor. This type of control enables low-loss switching with a simple and space-saving structure.

It is advantageous if the voltage of the electric motor is regulated until standstill, if necessary. This makes it possible to highly protect the electric motor from overload.

A control and regulation circuit for the method according to the disclosure advantageously comprises at least one detection system, at least one computation and control unit, at least one circuit breaker and at least one electric motor.

The control and regulation circuit is advantageously used in a handheld power tool, in particular in an angle grinder.

### BRIEF DESCRIPTION OF THE DRAWINGS

The drawings illustrate the exemplary embodiment of a regulation circuit according to the disclosure for an electric motor.

In the drawings:

FIG. 1 shows a regulation circuit according to the disclosure for an electric motor of a handheld power tool

FIG. 2 shows a first graph showing a profile of the reduction of an armature voltage

FIG. 3 shows a second graph showing pulse width modulation of the voltage

FIG. 4 shows a third graph showing phase-gating control of the voltage

FIG. 5 shows a flowchart for limiting the power consumption of an electric motor of a handheld power tool in the event of overload

FIG. 6 shows a handheld power tool, in particular an angle grinder, having the regulation circuit according to the disclosure.

### DETAILED DESCRIPTION

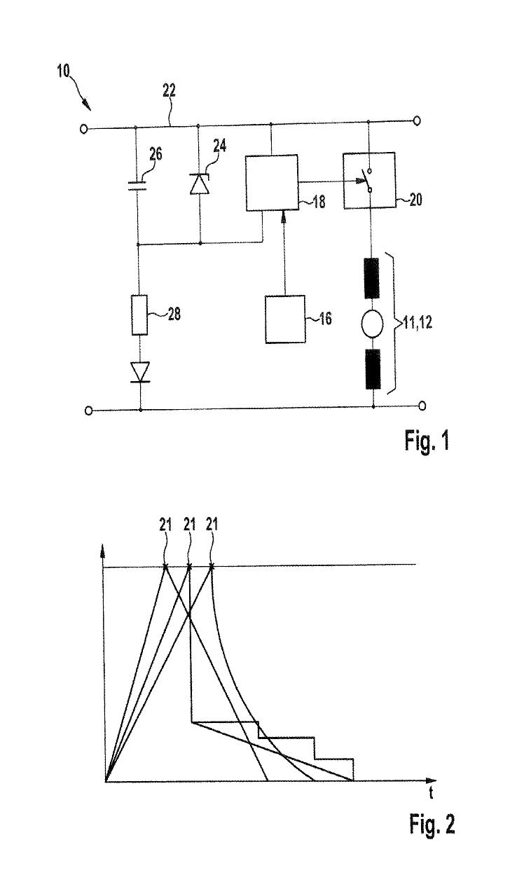

FIG. 1 shows a control and regulation circuit 10 according to the disclosure for controlling and/or regulating at least one electric motor 12 for a handheld power tool 14. The control and regulation circuit 10 has a detection system 16, a computation and control unit 18 and a circuit breaker 20.

In the exemplary embodiment in FIG. 1, the computation and control unit 18 is arranged between a first line 22 and the circuit breaker 20. A power supply for the computation and control unit 18 comprises a diode 24 which is connected in parallel with the computation and control unit 18. It also includes a capacitance 26 and a resistor 28.

The detection system 16 detects a parameter which characterizes a power consumption of the electrical drive, for example a speed, a current, an armature voltage and/or a temperature of the electric motor 12. This is effected either by detecting the speed using speedometer signal detection or by detecting the motor current using a measuring resistor or by detecting a voltage at the armature of the electric motor 12 or by detecting a temperature at the electric motor 12. In this case, either one parameter is monitored or a plurality of parameters are monitored in a parallel manner.

The detection system 16 is connected to the computation and control unit 18 and sends a value of the parameter which characterizes the power consumption to said computation and control unit.

The computation and control unit 18 evaluates the value of the parameter. One or more of the parameters can be measured and evaluated. If an actual value of one of the parameters differs from its desired value in an impermissible manner, a control signal for a voltage of the electric motor 12, in particular, is selected in such a manner that the power output to the electric motor is reduced. The computation and control unit 18 has, inter alia, a processor, a main memory and a program memory as well as interfaces which make it possible to communicate with the environment. In the exemplary embodiment, the computation and control unit 18 is a microcontroller. However, it is also conceivable to use other motor controllers which are implemented in an electronic circuit.

If an overload torque 21 and therefore the power consumption of the electric motor are exceeded, a control signal for the voltage of the electric motor 12 is adapted, with the result that the power consumption of the electric motor 12 is reduced and the handheld power tool 14 is operated in a protective mode. In the protective mode, the handheld power tool is operated with a defined, reduced power; in the exemplary embodiment, the power is between 600 W and 800 W in the protective mode. As illustrated in FIG. 2, the power is reduced in a stepwise or linear or exponentially progressive or exponentially degressive manner in an interval of time which is greater than an integer multiple of half the period time of the mains frequency. If the overload torque 21 is reduced in the protective mode, the speed of the electric motor 12 is increased again, in particular while monitoring the parameter which characterizes the power consumption. If the parameter which characterizes the power consumption is still outside a tolerable value after reducing the power consumption of the motor, the control signal for the voltage of the electric motor 12 continues to be adapted, with the result that the power consumption is reduced even further. This operation can be continued, if necessary, until the handheld power tool 14 comes to a standstill.

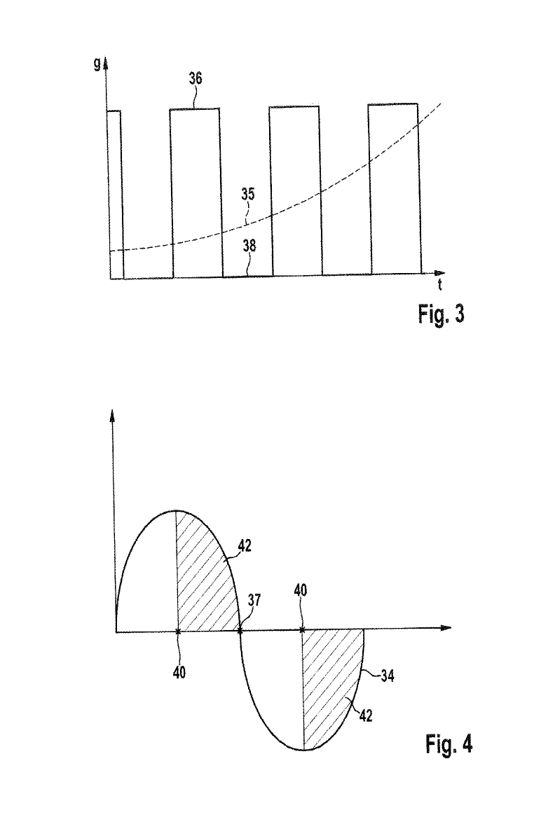

As illustrated in FIG. 3, the voltage of the electric motor 12 is regulated using pulse width modulation (PWM) of a voltage signal. In the graphs in FIG. 3, the time t is plotted on the horizontal axis. At the intersection points, an output signal is switched between two levels, the high level 36 and the low level 38. “High level” is intended to be understood as meaning the full signal strength. The low level has a signal strength of zero. The PWM signal 30 is generated with the aid of the circuit breaker 20 in such a manner that the power consumption of the electric motor 12 is reduced. This is achieved using a PWM signal which switches between a broad low level 38 and a narrow high level 36, when considered in terms of time.

FIG. 4 shows the method for phase-gating control of the voltage signal which is used to control and regulate the power consumption of the electric motor 12. In FIG. 4, the time t is plotted on the horizontal axis. FIG. 4 also shows an analog voltage signal 34 which is switched by the circuit breaker 20. After the zero crossing of the signal 34, the circuit breaker 20 does not switch the voltage of the electric motor 12 until it receives a firing pulse. From this time on (called the firing time 40), the electric motor 12 is supplied with energy until the next zero crossing.

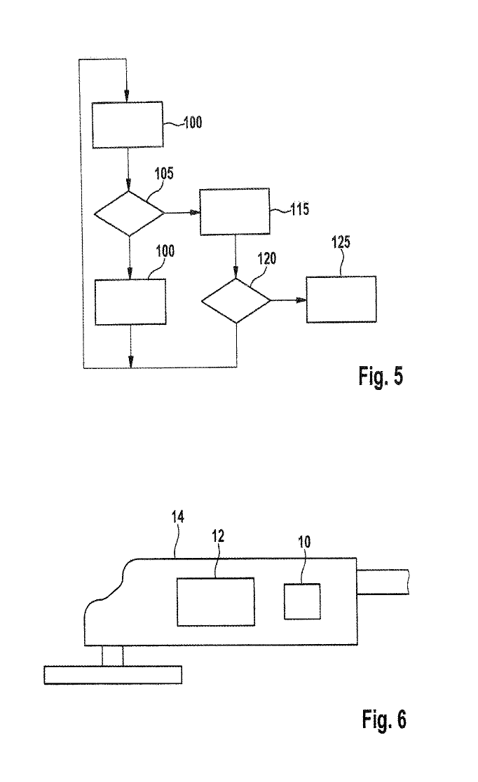

FIG. 5 shows a flowchart for regulating the power consumption of the electric motor 12.

In step 100, the method is in the starting state, that is to say the electric motor 12 is running and the values of the speed, current, armature voltage and temperature, which are monitored, are within their limit values. If a deviation of a parameter from its limit value is determined in method step 105, the control signal for the voltage of the electric motor 12 is adapted and the power consumption of the electric motor is reduced in step 115. This is carried out with the aid of the circuit breaker 20 which outputs a control signal for the voltage to the electric motor 12, which control signal is defined by the computation and control unit 18. The parameters of the speed and/or current and/or armature voltage and/or temperature are also monitored. In 120, complete switching-off of the handheld power tool 14 is queried. If switching-off is intended, this is carried out in step 125. After the handheld power tool 14 has been switched off by the control and regulation circuit 10, the handheld power tool can be started again only if the switching-off and switching-on again are carried out at a switch 40.

FIG. 6 shows a handheld power tool 14, in particular an angle grinder having the regulation circuit 10 according to the disclosure, the electric motor 12 and the switch 40. However, use in other handheld power tools, for example straight grinders, eccentric grinders, chainsaws or the like, is likewise possible.

What is claimed is:

1. A method for limiting a power consumption in the event of overload of an electrical drive by outputting power to the electrical drive, at least the voltage of the electric motor being controlled using at least one circuit breaker, the method comprising:
detecting at least one parameter that characterizes the power consumption of the electrical drive with a detection system;
calculating at least one control signal for the voltage of the electric motor from a desired value/actual value comparison of the parameter with a computation and control unit; and
adapting at least the control signal and therefore the power consumption of the electric motor if one or more of an overload torque and the power consumption is exceeded so as to operate the handheld power tool in a protective mode with a defined, reduced power consumption, at least the control signal for the voltage of the electric motor and therefore the power consumption of the electric motor being reduced in the protective mode with reduced power consumption in an interval of time that is greater than an integer multiple of half the period time of the mains frequency if the overload torque is not reduced.

2. The method according to claim 1, wherein the speed of the electric motor is increased again from the protective mode with reduced power consumption if the overload torque is reduced.

3. The method according to claim 1, wherein the parameter that characterizes the power consumption of the electrical drive continues to be monitored in the protective mode with reduced power consumption.

4. The method according to claim 1, wherein the voltage of the electric motor is reduced continuously in the mode with the reduced power consumption.

5. The method according to claim 4, wherein the voltage of the electric motor is reduced in a stepped manner in the mode with the reduced power consumption.

6. The method according to claim 4, wherein the voltage of the electric motor is reduced in an exponentially progressive manner in the mode with the reduced power consumption.

7. The method according to claim 4, wherein the voltage of the electric motor is reduced in an exponentially degressive manner in the mode with the reduced power consumption.

8. The method according to claim 4, wherein the voltage of the electric motor is regulated using pulse width modulation of an analog voltage signal.

9. The method according to claim 8, wherein the pulse-width-modulated signal is generated with the aid of the circuit breaker in such a manner that the power consumption of the electric motor is reduced.

10. The method according to claim 4, wherein the power consumption of the electric motor is regulated using phase-gating control of the analog voltage signal.

11. The method according to claim 10, wherein a firing angle of the phase-gating control is increased with the aid of the circuit breaker in order to reduce the voltage of the electric motor.

12. A regulation circuit for regulating one or more of a speed, a current, and a voltage of an electrical drive, comprising:
a detection system;
a computation and control unit;
a circuit breaker; and
an electric motor, the regulation circuit being configured to carry out a method for limiting a power consumption in the event of overload of the electric motor by outputting power to the electric motor, at least the voltage of the electric motor being controlled by the circuit breaker, the method including:
detecting at least one parameter that characterizes the power consumption of the electric motor with the detection system;
calculating at least one control signal for the voltage of the electric motor from a desired value/actual value comparison of the parameter with the computation and control unit; and
adapting at least the control signal and therefore the power consumption of the electric motor if one or more of an overload torque and the power consumption is exceeded so as to operate the electric motor in a protective mode with a defined, reduced power consumption, at least the control signal for the voltage of the electric motor and therefore the power consumption of the electric motor being reduced in the protective mode with reduced power consumption in an interval of time that is greater than an integer multiple of half the period time of the mains frequency if the overload torque is not reduced.

13. A handheld power tool, comprising:
a regulation circuit configured to regulate one or more of a speed, a current, and a voltage of an electrical drive, the regulation circuit including:
a detection system;
a computation and control unit;
a circuit breaker; and
an electric motor, the regulation circuit being configured to carry out a method for limiting a power consumption in the event of overload of the electric motor by outputting power to the electric motor, at least the voltage of the electric motor being controlled by the circuit breaker, the method including:
detecting at least one parameter that characterizes the power consumption of the electric motor with the detection system;
calculating at least one control signal for the voltage of the electric motor from a desired value/actual value comparison of the parameter with the computation and control unit; and
adapting at least the control signal and therefore the power consumption of the electric motor if one or more of an overload torque and the power consumption is exceeded so as to operate the handheld power tool in a protective mode with a defined, reduced power consumption, at least the control signal for the voltage of the electric motor and therefore the power consumption of the electric motor being reduced in the protective mode with reduced power consumption in an interval of time that is greater than an integer multiple of half the period time of the mains frequency if the overload torque is not reduced.

14. The method according to claim 1, wherein the electrical drive is configured as an electric motor of a handheld power tool.

15. The method according to claim 4, wherein the voltage of the electric motor is reduced linearly in the mode with the reduced power consumption.

16. The regulation circuit according to claim 12, wherein the electrical drive is configured as an electric motor of a handheld power tool.
